(19) United States
(12) Patent Application Publication
(10) Pub. No.: US 2017/0213183 A1
(43) Pub. Date: Jul. 27, 2017

(54) LOGISTICS SYSTEM AND LOGISTICS DISTRIBUTION METHOD AND SYSTEM

(71) Applicant: ALIBABA GROUP HOLDING LIMITED, Grand Cayman (KY)

(72) Inventor: BIN HU, HANGZHOU (CN)

(21) Appl. No.: 15/406,463

(22) Filed: Jan. 13, 2017

(30) Foreign Application Priority Data
Jan. 22, 2016 (CN) 201610046736.1

(51) Int. Cl. G06Q 10/08

(52) U.S. Cl. CPC G06Q 10/083

(57) ABSTRACT

A logistics distribution method is disclosed. The method may comprise converting, by a logistics system, one or more receiver addresses corresponding to one or more packages into one or more address identifiers corresponding to the one or more receiver addresses, according to a pre-stored address library and a preset address conversion rule. The method may further comprise sending, by the logistics system, the one or more address identifiers to one or more carrier systems for logistics distribution of the one or more packages.

### CROSS REFERENCE TO RELATED APPLICATION

The present application is based on and claims the benefit of priority to Chinese Application No. 201610046736.1, filed on Jan. 22, 2016, the entire contents of which are incorporated herein by reference.

### BACKGROUND

Technical Field

This disclosure relates to the field of logistics distribution technologies, and in particular, to a logistics system and a logistics distribution method and system.

Related Art

In a cross-border logistics chain, a domestic logistics provider generally packs a plurality of packages to be sent to the same destination country into a large package, and a destination country logistics provider needs to unpack the large package upon receipt, to sort the plurality of packages in the large package according to destination cities of the packages, and then have the sorted packages distributed.

However, in the logistics distribution method in the related art, receivers' addresses are often written in languages of the destination countries, which causes difficulties for a domestic logistics provider to sort the packages. For example, the packages can be sorted only at a destination country level, and cannot be sorted at a finer level, for example, a state/province level. This results in a waste of time, labor, and resources, and a decrease in logistics distribution efficiency, and undermines user experience.

### SUMMARY

This disclosure is intended to at least resolve one of the technical problems in the related art to a particular extent. Therefore, a first objective of this disclosure is to provide a logistics distribution method. The method can improve logistics distribution efficiency, and is simple and convenient.

A second objective of this disclosure is to provide a logistics distribution system.

A third objective of this disclosure is to provide a logistics system.

To achieve the foregoing objectives, a logistics distribution method according to an embodiment of a first aspect of this disclosure is provided, which includes the following steps: converting, by a logistics system, one or more receiver addresses corresponding to one or more packages into one or more address identifiers corresponding to the one or more receiver addresses, according to a pre-stored address library and a preset address conversion rule; sending, by the logistics system, the one or more address identifiers to one or more carrier systems for logistics distribution of the one or more packages.

In the logistics distribution method in this embodiment of the disclosure, a receiver address is converted into an address identifier corresponding to the receiver address, and the address identifier is sent to an order-receiving carrier system and a distribution carrier system, so that a large package does not need to be unpacked, and addresses can be labeled quickly. The order-receiving carrier system and distribution carrier system, in some embodiments, can be separate systems, and in some other embodiments, can be implemented by one system, e.g., one computer or server system and owned by one entity. The method is applicable to international logistics distribution, eliminates language barriers, and facilitates distribution, which not only effectively improves logistics distribution efficiency, but also saves time and labor, reduces distribution costs, and makes distribution more scientific and appropriate. Problems such as package loss caused by unpacking are also reduced while improving the distribution efficiency. To achieve the foregoing objectives, a logistics distribution system according to an embodiment of a second aspect of this disclosure includes: one or more carrier systems; and a logistics system, configured to convert, during shipment, one or more receiver addresses corresponding to one or more packages into one or more address identifiers corresponding to the one or more receiver addresses, according to a pre-stored address library and a preset address conversion rule, and send the one or more address identifiers to the one or more carrier systems for logistics distribution of the one or more packages.

In the international logistics distribution system in the embodiment of this disclosure, a receiver address is converted into an address identifier corresponding to the receiver address, and the address identifier is sent to an order-receiving carrier system and a distribution carrier system, so that a large package does not need to be unpacked, and addresses can be labeled quickly. The system is applicable to international logistics distribution, eliminates language barriers, and facilitates distribution, which not only effectively improves logistics distribution efficiency, but also saves time and labor, reduces distribution costs, and makes distribution more scientific and appropriate. Problems such as package loss caused by unpacking are also reduced while improving the distribution efficiency.

To achieve the foregoing objectives, a logistics system according to an embodiment of a third aspect of this disclosure is provided, which includes: a receiving module configured to receive one or more receiver addresses corresponding to one or more packages; an address identifier generation module configured to convert one or more receiver addresses corresponding to one or more packages into one or more address identifiers corresponding to the one or more receiver addresses, according to a pre-stored address library and a preset address conversion rule; and a sending module configured to send the one or more address identifiers to one or more carrier systems for logistics distribution of the one or more packages.

In the logistics system in this embodiment of the disclosure, a receiver address is converted into an address identifier corresponding to the receiver address, and the address identifier is sent to an order-receiving carrier system and a distribution carrier system, so that a large package does not need to be unpacked, and addresses can be labeled quickly. The system is applicable to international logistics distribution, eliminates language barriers, and facilitates distribution, which not only effectively improves logistics distribution efficiency, but also saves time and labor, reduces distribution costs, and makes distribution more scientific and appropriate. Problems such as package loss caused by unpacking are also reduced while improving the distribution efficiency.

Additional aspects and advantages of this disclosure will be set forth in part in the description which follows and, in part, will be obvious from the description, or may be learned by practice of this disclosure.

### BRIEF DESCRIPTION OF THE DRAWINGS

The foregoing and/or additional aspects and advantages of this disclosure will become apparent and more readily appreciated from the following description of the embodiments, taken in conjunction with the accompanying drawings of which:

FIG. 1 is a flowchart of a logistics distribution method according to an embodiment of this disclosure;

FIG. 2 is a flowchart of a logistics distribution method according to an embodiment of this disclosure;

FIG. 3 is a flowchart of a logistics distribution method according to another embodiment of this disclosure;

FIG. 4 is a flowchart of a logistics distribution method according to a further embodiment of this disclosure;

FIG. 5 is a schematic structural diagram of a logistics distribution system according to an embodiment of this disclosure;

FIG. 6 is a schematic structural diagram of a logistics distribution system according to an embodiment of this disclosure; and

FIG. 7 is a schematic structural diagram of a logistics system according to an embodiment of this disclosure.

### DETAILED DESCRIPTION

Embodiments of this disclosure are described in detail below, examples of which are illustrated in the accompany drawings, where identical or similar reference signs refer to identical or similar elements or elements having identical or similar functions throughout. The embodiments described below with reference to the accompany drawings are only exemplary and are intended to explain this disclosure, and shall not be understood as a limitation to this disclosure. On the contrary, the embodiments of this disclosure include all the variations, modifications, and equivalents that fall within the spirit and scope of the appended claims.

In the description of this disclosure, it should be understood that terms such as “first” and “second” are merely for a descriptive purpose, and are not to be understood to indicate or imply relative importance. The specific meanings about the foregoing terms in this disclosure may be understood by persons of ordinary skill in the art according to specific circumstances. Besides, in the description of this disclosure, unless illustrated otherwise, “a plurality of” means two or more than two.

The description in the flowcharts or the description of any process or method in other manners may be understood as being indicative of including one or more modules, segments or parts for realizing the codes of executable instructions of the steps in specific logic functions or processes, and that the scope of the preferred embodiments of this disclosure include other implementations, where the functions may be executed in manners different from those shown or discussed, including executing the functions according to the related functions in a substantially simultaneous manner or in a reverse order, which should be understood by persons skilled in the art to which this disclosure pertains.

A logistics system and a logistics distribution method and system according to the embodiments of this disclosure are described below with reference to accompanying drawings. The logistics system can be a fourth party logistics (4PL) system, a supply chain integrate system/logistics integrate system, or one or more carrier systems. The logistics system is a supply chain integrator, and the logistics system can be configured to mobilize and manage resources, capabilities, and technologies provided by the logistics system and other complementary services, so as to provide an integrated supply chain solution. That is, the logistics system can cooperate with other carrier systems to provide a buyer and a seller with a complete logistics service.

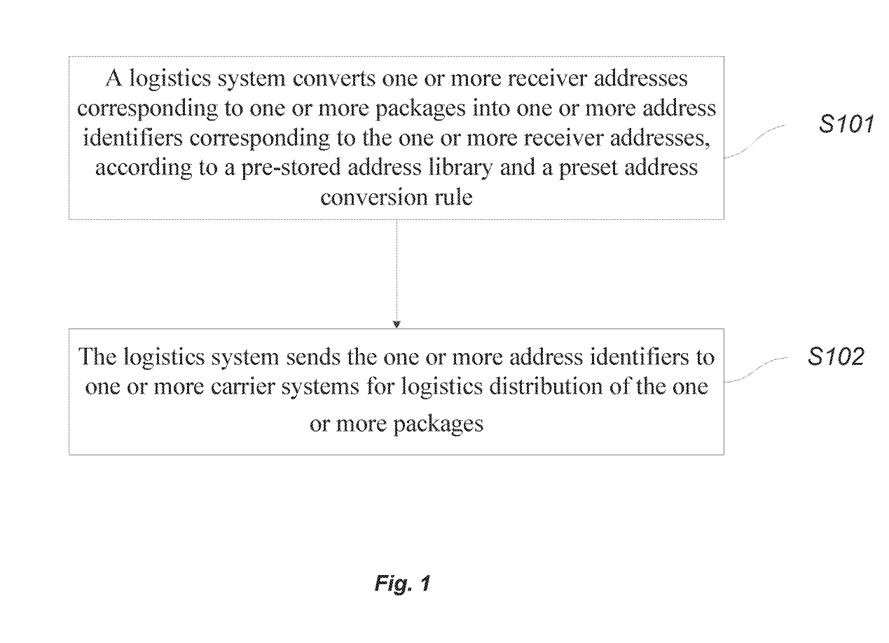

FIG. 1 is a flowchart of a logistics distribution method according to an embodiment of this disclosure.

As shown in FIG. 1, using domestic logistics as an example, the logistics distribution method includes the following steps:

S101: A logistics system converts, e.g., during shipment, one or more receiver addresses corresponding to one or more packages into one or more address identifiers corresponding to the one or more receiver addresses, according to a pre-stored address library and a preset address conversion rule.

The address conversion rule may be set according to actual situations, the preset address conversion rule may include an address-identifier correspondence library, and details are described below by using the address-identifier correspondence library as an example.

In an embodiment of this disclosure, the address library may include address names (for example, province names and city names), and the address-identifier correspondence library includes: the address names and identifiers corresponding to the address names. The step of converting, by a logistics system during shipment, one or more receiver addresses corresponding to one or more packages into one or more address identifiers corresponding to the one or more receiver addresses, according to a pre-stored address library and a preset address conversion rule may include: performing word segmentation on the one or more receiver addresses to obtain a plurality of segmented phrases; performing matching between the plurality of segmented phrases and the address library to obtain one or more matched address names; searching the address-identifier correspondence library for one or more identifiers corresponding to the one or more address names; and combining the one or more identifiers of the one or more address names to obtain the one or more address identifiers corresponding to the one or more receiver addresses.

The logistics system may search, according to a receiver address and by using a particular method, the address library for matched address information. The particular method may be a word segmentation method. For example, first, word segmentation is performed on the receiver address to obtain a plurality of segmented phrases, so as to perform matching between the plurality of segmented phrases and the address library, for example, if the receiver address is: “Hangzhou, Zhejiang”, “Zhejiang” and “Hangzhou” are obtained after the word segmentation and the matching; second, the address-identifier correspondence library is searched for corresponding identifiers: an identifier corresponding to “Zhejiang” may be “10”, and an identifier corresponding to “Hangzhou” may be “HZ”; and finally, the plurality of identifiers are combined to obtain an address identifier corresponding to the receiver address: “10-HZ”. The address identifier may be specific to a province (state), or may be specific to a city, which is not specifically limited in this disclosure.

Optionally, in an embodiment of this disclosure, the identifier corresponding to the address name may be: a number, a letter/letters, and/or a number-letter combination. For example, an identifier corresponding to Hangzhou may be “01”, “HZ”, or “01HZ”.

S102: The logistics system sends the one or more address identifiers to one or more carrier systems for logistics distribution of the one or more packages.

In an embodiment of this disclosure, the one or more carrier systems include: an order-receiving carrier system and a distribution carrier system.

In an embodiment of this disclosure, the order-receiving carrier and the distribution carrier may be the same entity.

The order-receiving carrier and the distribution carrier may be integrated as the same carrier entity, that is, the carrier system is responsible for receiving and transiting a package, and is also responsible for distributing the package. In some other embodiments, the order-receiving carrier system and distribution carrier system can be separate systems.

Further, in an embodiment of this disclosure, the distribution carrier system includes: one or more transit carrier systems and one or more terminal distribution carrier systems.

There may be a plurality of carrier systems. For example, the carrier systems may be classified into an order-receiving carrier system and a distribution carrier system according to functional roles of the carrier systems. The order-receiving carrier system is responsible for tasks of receiving and transiting a package, and finally sends the package to the distribution carrier system for terminal distribution.

In an embodiment of this disclosure, a large package does not need to be unpacked, which not only effectively improves logistics distribution efficiency, but also saves time and labor, reduces distribution costs, and makes distribution more scientific and appropriate. Problems such as package loss caused by unpacking are also reduced while improving the distribution efficiency.

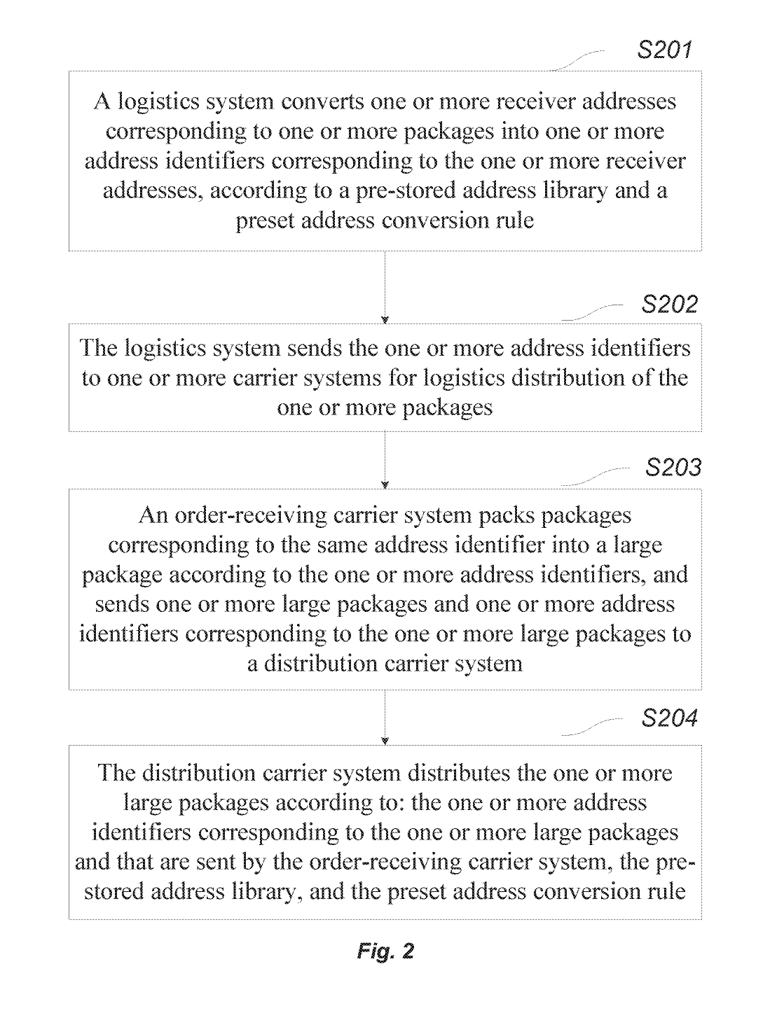

FIG. 2 is a flowchart of a logistics distribution method according to an embodiment of this disclosure.

Further, in an embodiment of this disclosure, as shown in FIG. 2, the logistics distribution method according to the embodiments of this disclosure includes:

S201: A logistics system converts, during shipment, one or more receiver addresses corresponding to one or more packages into one or more address identifiers corresponding to the one or more receiver addresses, according to a pre-stored address library and a preset address conversion rule.

S202: The logistics system sends the one or more address identifiers to one or more carrier systems for logistics distribution of the one or more packages.

S203: An order-receiving carrier system packs packages corresponding to the same address identifier into a large package according to the one or more address identifiers, and sends one or more large packages and one or more address identifiers corresponding to the one or more large packages to a distribution carrier system.

In an embodiment of this disclosure, the address identifier may include at least a first identifier corresponding to a destination country and a second identifier corresponding to a destination state/province, and the preset address conversion rule includes an address-identifier correspondence library; and the step of packing, by an order-receiving carrier system, packages corresponding to the same address identifier into a large package according to the one or more address identifiers, and sending one or more large packages and one or more address identifiers corresponding to the one or more large packages to a distribution carrier system includes: packing packages corresponding to the same address identifier into a large package, and adding the address identifier to the large package; and sending the large package to the distribution carrier system.

In this embodiment of the disclosure, by means of a first identifier corresponding to a destination country, the logistics distribution method according to this embodiment of the disclosure not only can be applied to domestic logistics distribution, but also be applied to international logistics distribution (which is described in the following embodiment in detail). In addition, sorting and distribution can be directly performed by means of a second identifier corresponding to a destination state/province, which achieves higher logistics distribution efficiency, and saves time and labor.

Besides, the order-receiving carrier system packs packages corresponding to the same address identifier into a large package according to the one or more address identifiers, and adds the address identifier corresponding to the large package to the large package, which helps the distribution carrier system to sort and distribute one or more large packages according to the address-identifier correspondence library and one or more address identifiers added to the one or more large packages.

Further, in an embodiment of this disclosure, as shown in FIG. 2, the logistics distribution method according to the embodiments of this disclosure further includes:

S204: The distribution carrier system distributes the one or more large packages according to: the one or more address identifiers corresponding to the one or more large packages and that are sent by the order-receiving carrier system, the pre-stored address library, and the preset address conversion rule.

In an embodiment of this disclosure, the step of distributing, by the distribution carrier system, the one or more large packages according to the one or more address identifiers corresponding to the one or more large packages and that are sent by the order-receiving carrier system, the pre-stored address library, and the preset address conversion rule may include: sorting the one or more large packages according to the one or more address identifiers adhering to the one or more large packages; and distributing the one or more large packages to one or more corresponding destination states/provinces according to the address-identifier correspondence library and the address library.

After receiving the one or more large packages from the order-receiving carrier system, the distribution carrier system sorts the one or more large packages according to the one or more address identifiers adhering to the one or more large packages, and then distributes the one or more large packages. The one or more large packages do not need to be unpacked for sorting and distribution, which improves logistics distribution efficiency.

Besides, in an embodiment of this disclosure, the logistics distribution method according to the embodiments of this disclosure further includes: creating, by the logistics system, the address library according to address names, and storing the address library; or downloading, by the logistics system, the address library from a cloud server, and storing the address library. That is, the pre-stored address library may be created by the logistics system, and a creation method may include creating the address library according to address names, or downloading the address library from a cloud server, so as to generate address identifiers that can be identified by the carrier systems, so that the order-receiving carrier system may perform packing according to the address identifiers, and the distribution carrier system can perform sorting and distribution according to the address identifiers, thereby reducing sorting steps, and saving time and labor.

In the logistics distribution method according to this embodiment of the disclosure, a logistics system converts a receiver address into an address identifier corresponding to the receiver address according to an address library and an address conversion rule, so that an order-receiving carrier system packs packages corresponding to the same address identifier into a large package, and a distribution carrier system directly sorts and distributes one or more large packages according to the address conversion rule and one or more address identifiers corresponding to the one or more large packages. The one or more large packages do not need to be unpacked, which not only effectively improves logistics distribution efficiency, but also saves time and labor, reduces distribution costs, and makes distribution more scientific and appropriate. Problems such as package loss caused by unpacking are also reduced while improving the distribution efficiency.

International logistics distribution is described in detail below.

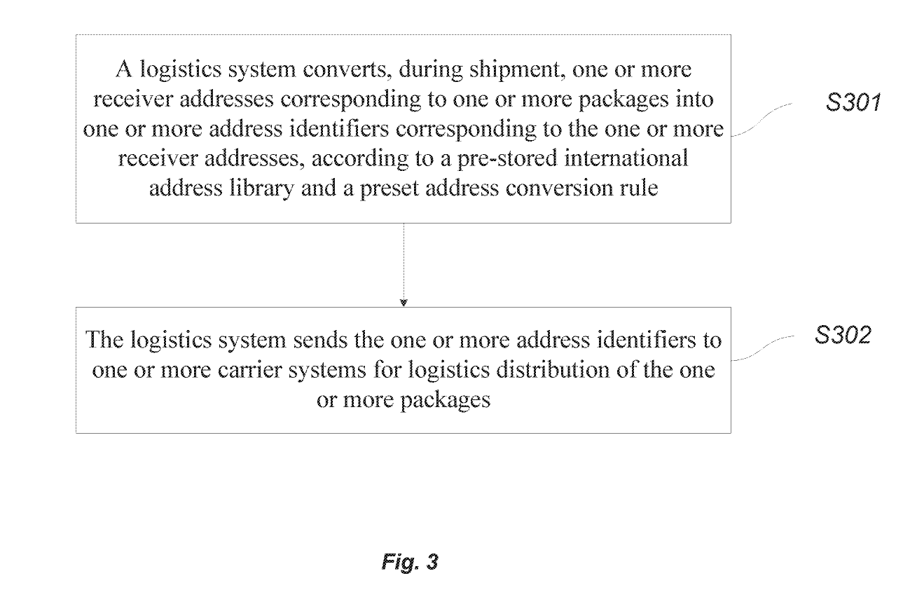

As shown in FIG. 3, using international logistics as an example, the logistics distribution method includes the following steps:

S301: A logistics system converts, during shipment, one or more receiver addresses corresponding to one or more packages into one or more address identifiers corresponding to the one or more receiver addresses, according to a pre-stored international address library and a preset address conversion rule.

The address conversion rule may be set according to actual situations, the preset address conversion rule may include an address-identifier correspondence library, and details are described below by using the address-identifier correspondence library as an example.

The logistics system is a supply chain integrator, and the logistics system can be configured to mobilize and manage resources, capabilities, and technologies provided by the logistics system and other complementary services, so as to provide an integrated supply chain solution. Particularly, in the logistics system for cross-border electronic commerce, the logistics system can cooperate with carrier systems such as a domestic logistics provider, an international arterial logistics provider, and a destination country logistics provider, so as to provide a buyer and a seller with a complete cross-border logistics service.

In an embodiment of this disclosure, the logistics distribution method according to the embodiments of this disclosure further includes: creating, by the logistics system, the international address library according to international address names, and storing the international address library; or downloading, by the logistics system, the international address library from a cloud server, and storing the international address library.

That is, the pre-stored international address library may be created by the logistics system provider, and a creation method may include creating the international address library according to international address names, or downloading the international address library from a cloud server, so as to generate address identifiers that can be identified by carrier systems of countries, so that a domestic order-receiving carrier system may perform packing according to the address identifiers, and an international distribution carrier system and a destination country distribution carrier system can perform sorting and distribution according to the address identifiers, thereby reducing sorting steps, and saving time and labor.

Further, in an embodiment of this disclosure, the international address library may include: international address names (for example, country names and state/province names). An identifier corresponding to an international address name may be a number, a letter/letters, and/or a number-letter combination. For example, an identifier corresponding to Hangzhou may be “01”, “HZ”, or “01HZ”. The address-identifier correspondence library is equivalent to the foregoing set rule, and may include: the international address names and identifiers corresponding to the international address names, for example, Hangzhou and an identifier corresponding to Hangzhou, for example, “01”, “HZ”, or “01HZ”.

Further, in an embodiment of this disclosure, the logistics system provider receives a receiver address, and generates an address identifier corresponding to the receiver address according to the pre-stored international address library and the address-identifier correspondence library, which includes: performing word segmentation on the receiver address to obtain a plurality of segmented phrases; performing matching between the plurality of segmented phrases and the international address library to obtain one or more matched international address names; searching the address-identifier correspondence library for one or more identifiers corresponding to the one or more international address names; and combining the one or more identifiers of the one or more international address names to obtain the address identifier corresponding to the receiver address.

The logistics system may search, according to a receiver address and by using a particular method, the international address library for matched address information. The particular method may be a word segmentation method. For example, first, word segmentation is performed on the receiver address to obtain a plurality of segmented phrases, so as to perform matching between the plurality of segmented phrases and the international address library, for example, the receiver address is: “Hangzhou, Zhejiang, China, and China”, “Zhejiang”, and “Hangzhou” are obtained after the word segmentation and the matching; second, the address-identifier correspondence library is searched for corresponding identifiers: an identifier corresponding to “China” may be “CN”, an identifier corresponding to “Zhejiang” may be “10”, and an identifier corresponding to “Hangzhou” may be “HZ”; and finally, the plurality of identifiers are combined to obtain an address identifier of the receiver address: “CN-10-HZ”. The address identifier may be specific to a province (state), or may be specific to a city, which is not specifically limited in this disclosure.

S302: The logistics system sends the one or more address identifiers to one or more carrier systems for logistics distribution of the one or more packages.

In an embodiment of international distribution, there may be a plurality of carrier systems. For example, the carrier systems may be classified into an order-receiving carrier system and a distribution carrier system according to functional roles of the carrier systems. The order-receiving carrier system is responsible for tasks of receiving and transiting a package, and finally sends the package to the distribution carrier system for terminal distribution. When an international transportation route is very long, the distribution carrier system may be further classified into: one or more transit carrier systems and a terminal distribution carrier system, that is, one or more transit carrier systems are responsible for the transit of a package within a country or between countries and finally delivers the package to a terminal distribution carrier system in a destination for terminal distribution. It should be understood by persons skilled in the art that the plurality of transit carrier systems may cooperate with each other for the transit. Similarly, in another example, the order-receiving carrier and the distribution carrier may be integrated as the same carrier entity, that is, the carrier system is responsible for receiving and transiting a package, and is also responsible for distributing the package.

In this embodiment of the disclosure, a large package does not need to be unpacked, which not only effectively improves logistics distribution efficiency, but also saves time and labor, reduces distribution costs, and makes distribution more scientific and appropriate. Problems such as package loss caused by unpacking are also reduced while improving the distribution efficiency. In addition, cross-border package logistics is performed, and receiver addresses are usually written in a plurality of languages, and therefore, address identifiers are sent to all carrier systems, so as to convert the receiver addresses in the plurality of languages into identifiers that can be identified by the carrier systems, thereby eliminating language barriers, and further improving the distribution efficiency.

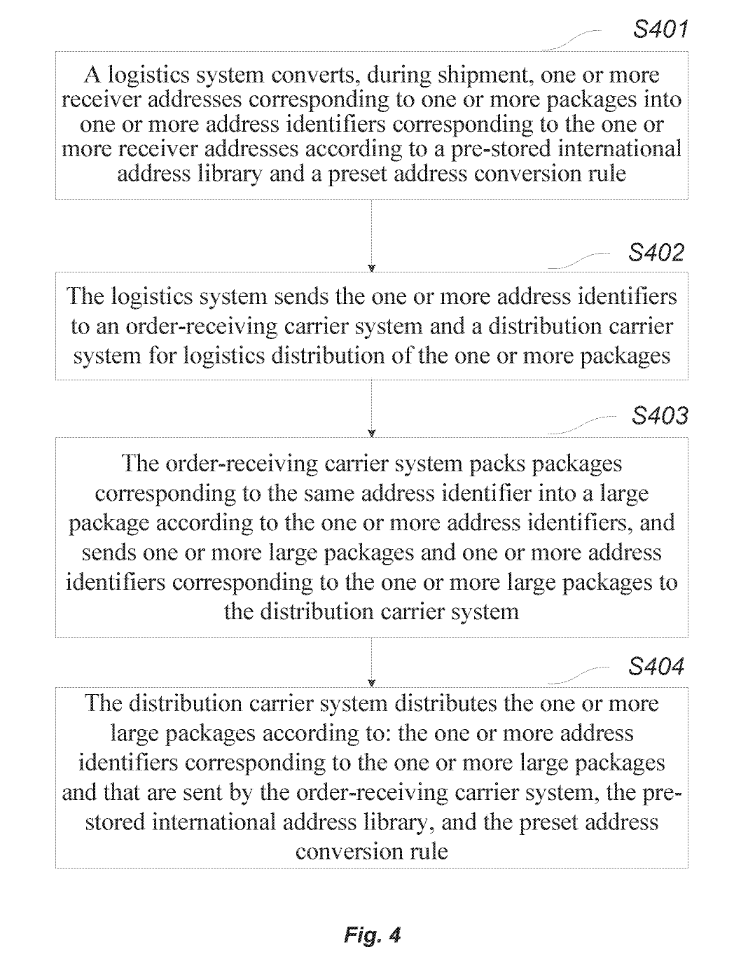

Further, in an embodiment of this disclosure, as shown in FIG. 4, the international logistics distribution method according to the embodiments of this disclosure further includes:

S401: A logistics system converts, during shipment, one or more receiver addresses corresponding to one or more packages into one or more address identifiers corresponding to the one or more receiver addresses according to a pre-stored international address library and a preset address conversion rule.

S402: The logistics system sends the one or more address identifiers to an order-receiving carrier system and a distribution carrier system for logistics distribution of the one or more packages.

S403: The order-receiving carrier system packs packages corresponding to the same address identifier into a large package according to the one or more address identifiers, and sends one or more large packages and one or more address identifiers corresponding to the one or more large packages to the distribution carrier system.

In an embodiment of this disclosure, the address identifier may include at least a first identifier corresponding to a destination country and a second identifier corresponding to a destination state/province, and the preset address conversion rule includes an address-identifier correspondence library; and the step of packing, by the order-receiving carrier system, packages corresponding to the same address identifier into a large package according to the one or more address identifiers, and sending one or more large packages and one or more address identifiers corresponding to the one or more large packages to the distribution carrier system includes: packing packages corresponding to the same address identifier into a large package, and adding the address identifier to the large package; and sending the large package to the distribution carrier system.

In this embodiment of the disclosure, by means of a first identifier corresponding to a destination country, the logistics distribution method according to this embodiment of the disclosure not only can be applied to domestic logistics distribution, but also be applied to international logistics distribution, which eliminates language barriers. In addition, sorting and distribution can be directly performed by means of a second identifier corresponding to a destination state/province, which achieves higher logistics distribution efficiency and saves time and labor as compared with performing sorting and distribution according to the first identifier corresponding to the destination country.

Besides, the order-receiving carrier system packs packages corresponding to the same address identifier into a large package according to the one or more address identifiers, and adds the address identifier corresponding to the large package to the large package, which helps the distribution carrier system to sort and distribute one or more large packages according to the address-identifier correspondence library and one or more address identifiers added to the one or more large packages.

For example, after receiving packages that are sent, a domestic logistics provider identifies destination provinces (states) or cities according to received address identifiers, stores the packages by category, when the domestic logistics provider transfers the packages, packs the packages into a large package according to a province (state) or city level, adheres an address identifier to the large package, and transfers the large package, so as to send the large package to a corresponding destination country logistics provider.

S404: The distribution carrier system distributes the one or more large packages according to: the one or more address identifiers corresponding to the one or more large packages and that are sent by the order-receiving carrier system, the pre-stored international address library, and the preset address conversion rule.

In an embodiment of this disclosure, the step of distributing, by the distribution carrier system, the one or more large packages according to the one or more address identifiers corresponding to the one or more large packages and that are sent by the order-receiving carrier system, the pre-stored address library, and the preset address conversion rule includes: sorting the one or more large packages according to the one or more address identifiers adhering to the one or more large packages; and distributing the one or more large packages to one or more corresponding destination states/provinces according to the address-identifier correspondence library and the address library.

After receiving the one or more large packages from the order-receiving carrier system, the distribution carrier system sorts the one or more large packages according to the one or more address identifiers adhering to the one or more large packages, and then distributes the one or more large packages. The one or more large packages do not need to be unpacked for sorting and distribution, which improves logistics distribution efficiency.

In this embodiment of the disclosure, in combination with the address library and the address-identifier correspondence library, the logistics system may search, according to information about a receiver address filled by a buyer, such as country, province (state), and city, the address library for matched address information, and converts, according to a set rule, the address information into an address identifier that can be identified by carrier systems, such as the domestic logistics provider and the destination country logistics provider. After receiving the address identifier, the order-receiving carrier system can pack packages to be sent to the same province (state) or the same city into a large package according to the address identifier, so that after receiving the large package, the distribution carrier system can directly perform sorting and distribution according to the province (state) or city of the large package without unpacking the large package and sorting the packages in the large package one by one, thereby saving time and labor and effectively improve logistics distribution efficiency.

For example, the receiver address is: “Yuhang district, Hangzhou, Zhejiang, China”, the logistics system may generate, according to the international address library and the address-identifier correspondence library, an address identifier corresponding to the receiver address: “CN-10” or “CN-10-HZ”, where “CN” represents the country—China, “10” represents the province—Zhejiang, and “HZ” represents the city—“Hangzhou”. For another example, the receiver address is: “Houston, Tex., United States”, the logistics system may generate, according to the international address library and the address-identifier correspondence library, an address identifier corresponding to the receiver address: “USA-05” or “USA-05-HT”, where “USA” represents the country—United States, “10” represents the state—Texas, and “HT” represents the city—Houston. Further, using international logistics as an example, for example, during shipment from United States to China, a domestic logistics provider in the United States, that is, an order-receiving carrier system, may pack packages corresponding to the same address identifier, for example, “Zhejiang”, or “Hangzhou, Zhejiang”, into a large package, and a destination country logistics provider in China, that is, a distribution carrier system, may directly perform sorting according to the identifier “Zhejiang” or the identifier “Hangzhou”, so as to distribute the packages to destinations, so that users can receive the packages as soon as possible, a language barrier is eliminated, and requirements on delivery staff are lowered.

In the logistics distribution method according to this embodiment of the disclosure, a logistics system converts a receiver address into an address identifier corresponding to the receiver address according to an address library and an address conversion rule, so that an order-receiving carrier system packs packages corresponding to the same address identifier into a large package, and a distribution carrier system directly sorts and distributes one or more large packages according to the address conversion rule and one or more address identifiers corresponding to the one or more large packages. The one or more large packages do not need to be unpacked, language barriers are eliminated, and requirements on delivery staff are lowered, which not only effectively improves logistics distribution efficiency, but also saves time and labor, reduces distribution costs, and makes distribution more scientific and appropriate. Problems such as package loss caused by unpacking are also reduced while improving the distribution efficiency.

To implement the foregoing embodiments, an embodiment of this disclosure further provides a logistics distribution system.

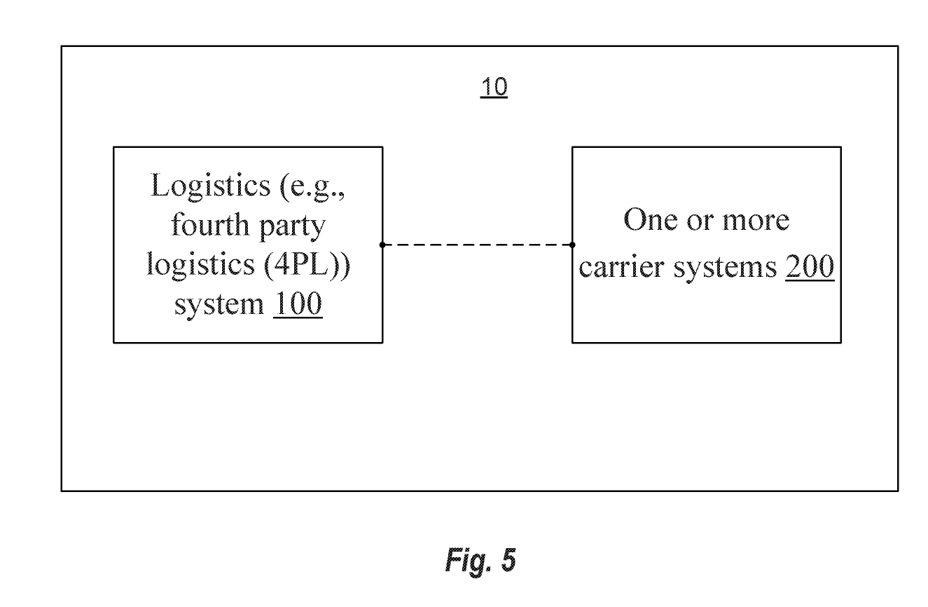

FIG. 5 is a schematic structural diagram of a logistics distribution system according to an embodiment of this disclosure.

As shown in FIG. 5, a logistics distribution system 10 includes: a logistics system 100 and one or more carrier systems 200.

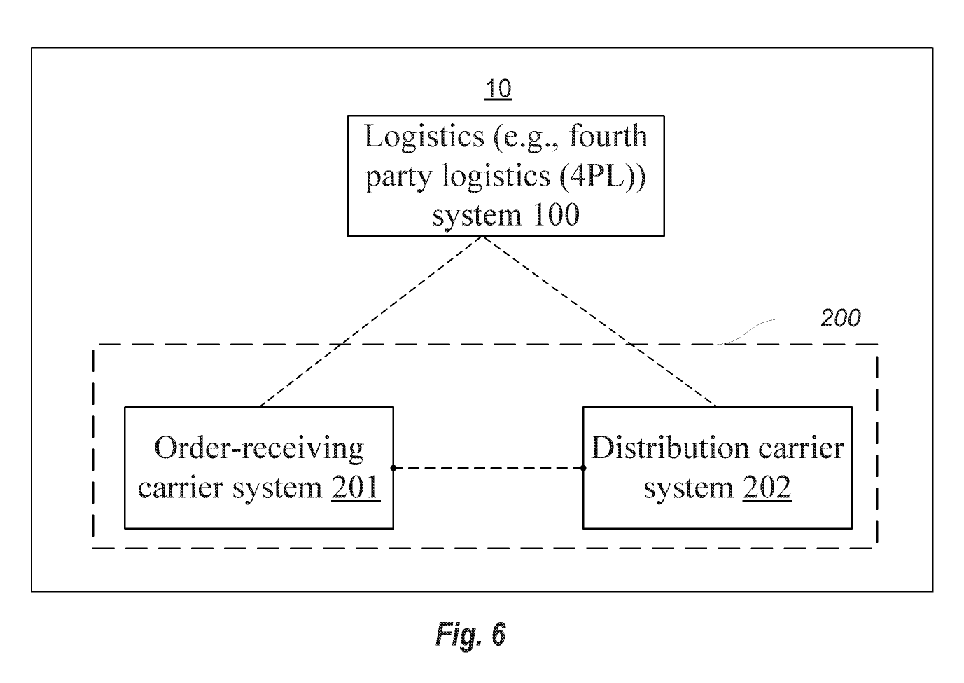

The logistics system 100 is configured to convert, during shipment, one or more receiver addresses corresponding to one or more packages into one or more address identifiers corresponding to the one or more receiver addresses, according to a pre-stored address library and a preset address conversion rule, and send the one or more address identifiers to the one or more carrier systems 200 for logistics distribution of the one or more packages. FIG. 6 is a schematic structural diagram of a logistics distribution system according to an embodiment of this disclosure.

As shown in FIG. 6, the one or more carrier systems 200 include: an order-receiving carrier system 201 and a distribution carrier system 202. That is, the logistics distribution system 10 includes: the logistics system 100, the order-receiving carrier system 201, and the distribution carrier system 202.

The logistics system 100 is configured to convert, during shipment, one or more receiver addresses corresponding to one or more packages into one or more address identifiers corresponding to the one or more receiver addresses, according to a pre-stored address library and a preset address conversion rule, and send the one or more address identifiers to the order-receiving carrier system 201 and the distribution carrier system 202 for logistics distribution of the one or more packages. The address conversion rule may be set according to actual situations, and the preset address conversion rule may include an address-identifier correspondence library.

In an embodiment of this disclosure, the order-receiving carrier system 201 and the distribution carrier system 202 may belong to the same entity.

Further, in an embodiment of this disclosure, the distribution carrier system 202 includes: one or more transit carrier systems and a terminal distribution carrier system.

Further, in an embodiment of the disclosure, the order-receiving carrier system 100 packs packages corresponding to the same address identifier into a large package according to the one or more address identifiers, and sends one or more large packages and one or more address identifiers corresponding to the one or more large packages to the distribution carrier system 202.

Further, in an embodiment of this disclosure, the distribution carrier system 202 distributes the one or more large packages according to: the one or more address identifiers corresponding to the one or more large packages and that are sent by the order-receiving carrier system 201, the pre-stored address library, and the preset address conversion rule.

In this embodiment of the disclosure, a large package does not need to be unpacked, which not only effectively improves logistics distribution efficiency, but also saves time and labor, reduces distribution costs, makes distribution more scientific and appropriate, and improves user experience.

In an embodiment of the disclosure, the address identifier includes at least a first identifier corresponding to a destination country and a second identifier corresponding to a destination state/province, and the preset address conversion rule includes an address-identifier correspondence library; and the step of packing, by the order-receiving carrier system 201, packages corresponding to the same address identifier into a large package according to the one or more address identifiers, and sending one or more large packages and one or more address identifiers corresponding to the one or more large packages to the distribution carrier system 202 includes: packing packages corresponding to the same address identifier into a large package, and adding the address identifier to the large package; and sending the large package to the distribution carrier system 202.

In this embodiment of the disclosure, by means of a first identifier corresponding to a destination country, the logistics distribution system according to this embodiment of the disclosure not only can be applied to domestic logistics distribution, but also be applied to international logistics distribution. In addition, sorting and distribution can be directly performed by means of a second identifier corresponding to a destination state/province, which not only eliminates language barriers, but also achieves higher logistics distribution efficiency and saves time and labor.

Besides, the order-receiving carrier system 201 packs packages corresponding to the same address identifier into a large package according to the one or more address identifiers, and adds the address identifier corresponding to the large package to the large package, which helps the distribution carrier system to sort and distribute one or more large packages according to the address-identifier correspondence library and one or more address identifiers added to the one or more large packages.

Further, in an embodiment of this disclosure, the step of distributing, by the distribution carrier system 202, the one or more large packages according to the one or more address identifiers corresponding to the one or more large packages and that are sent by the order-receiving carrier system 201, the pre-stored address library, and the preset address conversion rule includes: sorting the one or more large packages according to the one or more address identifiers adhering to the one or more large packages; and distributing the one or more large packages to one or more corresponding destination states/provinces according to the address-identifier correspondence library and the address library.

After receiving the one or more large packages from the order-receiving carrier system 202, the distribution carrier system 201 sorts the one or more large packages according to the one or more address identifiers adhering to the one or more large packages, and then distributes the one or more large packages. The one or more large packages do not need to be unpacked for sorting and distribution, which improves logistics distribution efficiency.

Optionally, in an embodiment of this disclosure, the address library includes address names, and the address-identifier correspondence library includes: the address names and identifiers corresponding to the address names; and the step of converting, by the logistics system 100 during shipment, one or more receiver addresses corresponding to one or more packages into one or more address identifiers corresponding to the one or more receiver addresses, according to a pre-stored address library and a preset address conversion rule includes: performing word segmentation on the one or more receiver addresses to obtain a plurality of segmented phrases; performing matching between the plurality of segmented phrases and the address library to obtain one or more matched address names; searching the address-identifier correspondence library for one or more identifiers corresponding to the one or more address names; and combining the one or more identifiers of the one or more address names to obtain the one or more address identifiers corresponding to the one or more receiver addresses. The logistics system 100 may search, according to a receiver address by using a particular method, the address library for matched address information. The particular method may be a word segmentation method. For example, first, word segmentation is performed on the receiver address to obtain a plurality of segmented phrases, so as to perform matching between the plurality of segmented phrases and the address library, for example, the receiver address is: “Hangzhou, Zhejiang”, and “Zhejiang” and “Hangzhou” are obtained after the word segmentation and the matching; second, the address-identifier correspondence library is searched for corresponding identifiers: an identifier corresponding to “Zhejiang” may be “10”, and an identifier corresponding to “Hangzhou” may be “HZ”; and finally, the plurality of identifiers are combined to obtain an address identifier of the receiver address: “10-HZ”. The address identifier may be specific to a province (state), or may be specific to a city, which is not specifically limited in this disclosure.

Optionally, in an embodiment of this disclosure, the identifier corresponding to the address name may be: a number, a letter/letters, and/or a number-letter combination, for example, an identifier corresponding to “Hangzhou” may be “01”, “HZ”, or “01HZ”.

Besides, in an embodiment of this disclosure, the logistics system 100 creates the address library according to address names, and stores the address library; or the logistics system downloads the address library from a cloud server, and stores the address library.

That is, the pre-stored address library may be created by the logistics system 100, and a creation method may be creating the address library according to address names, or downloading the address library from a cloud server, so as to generate address identifiers that can be identified by the carrier systems, so that the order-receiving carrier system 201 may perform packing according to the address identifiers, and the distribution carrier system 202 can perform sorting and distribution according to the address identifiers, thereby reducing sorting steps, and saving time and labor.

The specific implementation manners of the logistics distribution system in this embodiment of the disclosure are similar to the specific implementation manners of the logistics distribution method part, and to reduce redundancy, details are not described herein again.

In the logistics distribution system according to this embodiment of the disclosure, a logistics system converts a receiver address into an address identifier corresponding to the receiver address according to an address library and an address conversion rule, so that an order-receiving carrier system packs packages corresponding to the same address identifier into a large package, and a distribution carrier system directly sorts and distributes one or more large packages according to the address conversion rule and one or more address identifiers corresponding to the one or more large packages without unpacking the one or more large packages. The logistics distribution system is applicable to international logistics distribution, and eliminates language barriers, which not only effectively improves logistics distribution efficiency, but also saves time and labor, reduces distribution costs, and makes distribution more scientific and appropriate. Problems such as package loss caused by unpacking are also reduced while improving the distribution efficiency. To implement the foregoing embodiments, an embodiment of this disclosure further provides a logistics system.

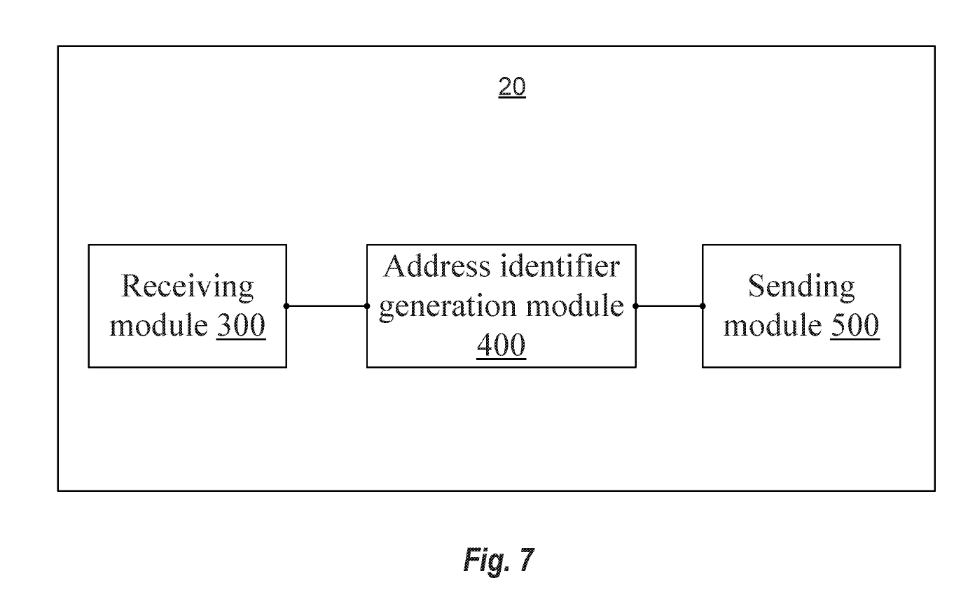

FIG. 7 is a schematic structural diagram of a logistics system according to an embodiment of this disclosure.

As shown in FIG. 7, a logistics system 20, for example, a 4PL system, includes: a receiving module 300, an address identifier generation module 400, and a sensing module 500. The receiving module 300 is configured to receive a receiver address. The address identifier generation module 400 is configured to convert one or more receiver addresses corresponding to one or more packages into one or more address identifiers corresponding to the one or more receiver addresses, according to a pre-stored address library and a preset address conversion rule. The sending module 500 is configured to send the one or more address identifiers to one or more carrier systems for logistics distribution of the one or more packages. With the logistics system 20 according to this embodiment of the disclosure, an address identifier corresponding to a receiver address can be generated according to the receiver address, so as to help a distribution carrier system to perform sorting and distribution, which not only effectively improves logistics distribution efficiency, but also reduces distribution costs. Problems such as package loss caused by unpacking are also reduced while improving the distribution efficiency.

In an embodiment of this disclosure, the one or more carrier systems include: an order-receiving carrier system and a distribution carrier system.

Optionally, in an embodiment of this disclosure, the order-receiving carrier system and the distribution carrier system may belong to the same entity.

Further, in an embodiment of this disclosure, the distribution carrier system includes: one or more transit carrier systems and a terminal distribution carrier system.

Optionally, in an embodiment of this disclosure, the address identifier includes at least a first identifier corresponding to a destination country and a second identifier corresponding to a destination state/province, and the preset address conversion rule includes an address-identifier correspondence library. Therefore, by means of the first identifier corresponding to the destination country, the logistics system not only can be applied to domestic logistics distribution, but also be applied to international logistics distribution. In addition, sorting and distribution can be directly performed by means of the second identifier corresponding to the destination state/province, which achieves higher logistics distribution efficiency, and saves time and labor.

Further, in an embodiment of this disclosure, the address library includes: address names, and the address-identifier correspondence library includes: the address names and identifiers corresponding to the address names; and the address identifier generation module 400 is configured to perform word segmentation on the one or more receiver addresses to obtain a plurality of segmented phrases, perform matching between the plurality of segmented phrases and the address library to obtain one or more matched international address names, search the address-identifier correspondence library for one or more identifiers corresponding to the one or more international address names, and combine the one or more identifiers of the one or more address names to obtain the one or more address identifiers corresponding to the one or more receiver addresses.

The address identifier generation module 400 may search, according to a receiver address by using a particular method, the address library for matched address information. The particular method may be a word segmentation method. For example, first, word segmentation is performed on the receiver address to obtain a plurality of segmented phrases, so as to perform matching between the plurality of segmented phrases and the international address library, for example, the receiver address is: “Hangzhou, Zhejiang, China”, and “China”, “Zhejiang”, and “Hangzhou” are obtained after the word segmentation and the matching; second, the address-identifier correspondence library is searched for corresponding identifiers: an identifier corresponding to “China” may be “CN”, an identifier corresponding to “Zhejiang” may be “10”, and an identifier corresponding to “Hangzhou” may be “HZ”; and finally, the plurality of identifiers are combined to obtain an address identifier corresponding to the receiver address: “CN-10-HZ”. The address identifier may be specific to a province (state), or may be specific to a city, which is not specifically limited in this disclosure.

Optionally, in an embodiment of this disclosure, the identifier corresponding to the international address name may be: a number, a letter/letters, and/or a number-letter combination. For example, an identifier corresponding to Hangzhou may be “01”, “HZ”, or “01HZ”. The identifier is simple, convenient, and easy to understand.

Besides, in an embodiment of this disclosure, the address identifier generation module 400 is further configured to create the address library according to address names, and store the address library; or download the address library from a cloud server, and store the address library.

That is, the pre-stored address library may be created by the address identifier generation module 400, and a creation method may be creating the address library according to address names, or downloading the address library from a cloud server, so as to generate address identifiers that can be identified by carrier systems of countries, so that packing is performed according to the address identifiers, and sorting and distribution are performed according to the address identifiers, thereby reducing sorting steps, and saving time and labor.

In the logistics system according to this embodiment of the disclosure, a receiver address is converted into an address identifier corresponding to the receiver address according to an address library and an address conversion rule, so that an order-receiving carrier system packs packages corresponding to the same address identifier into a large package, and a distribution carrier system directly sorts and distributes one or more large packages according to the address conversion rule and one or more address identifiers corresponding to the one or more large packages without unpacking the one or more large packages. The logistics distribution system is applicable to international logistics distribution, and eliminates language barriers, which not only effectively improves logistics distribution efficiency, but also saves time and labor, reduces distribution costs, and makes distribution more scientific and appropriate. Problems such as package loss caused by unpacking are also reduced while improving the distribution efficiency.

It should be understood that various parts of this disclosure may be implemented by means of hardware, software, firmware or a combination thereof. In the embodiments above, a plurality of steps or methods may be implemented by means of software or firmware stored in a memory and executed by an appropriate instruction execution system. For example, if implemented by means of hardware, as in another embodiment, they can be implemented by means of any one or a combination of the following techniques commonly known in the art: a discrete logical circuit having a logical gate circuit used for implementing a logical function on a data signal, a dedicated integrated circuit having an appropriate combinatorial logical gate circuit, a programmable gate array (PGA), a field programmable gate array (FPGA), and the like.

In the description of the present specification, the description of the reference terms such as “one embodiment”, “some embodiments”, “an example”, “a specific example” or “some examples” is intended to mean that a particular feature, structure, material or characteristic described in connection with the embodiment or example is included in at least one embodiment or example of this disclosure. In the present specification, the schematic expressions of the aforementioned terms do not necessarily refer to the same embodiment or example. Furthermore, particular features, structures, materials or characteristics described may be combined in a suitable manner in any one or more embodiments or examples.

Although the embodiments of this disclosure have been shown and described, it should be understood by persons of ordinary skill in the art that various changes, modifications, replacements and variations can be made to these embodiments without departing from the principle and spirit of this disclosure, and the scope of this disclosure is defined by the appended claims and equivalents thereof.

What is claimed is:

1. A logistics distribution method, comprising:
converting, by a logistics system, one or more receiver addresses corresponding to one or more packages into one or more address identifiers corresponding to the one or more receiver addresses, according to a pre-stored address library and a preset address conversion rule; and
sending, by the logistics system, the one or more address identifiers to one or more carrier systems for logistics distribution of the one or more packages.

2. The logistics distribution method according to claim 1, wherein the one or more carrier systems comprise: an order-receiving carrier system and a distribution carrier system.

3. The logistics distribution method according to claim 2, further comprising:
packing, by the order-receiving carrier system, packages corresponding to a same address identifier into a large package according to the one or more address identifiers, and sending one or more large packages and one or more address identifiers corresponding to the one or more large packages to the distribution carrier system; and
distributing, by the distribution carrier system, the one or more large packages according to: the one or more address identifiers that correspond to the one or more large packages and that are sent by the order-receiving carrier system, the pre-stored address library, and the preset address conversion rule.

4. The logistics distribution method according to claim 3, wherein:
the address identifier comprises at least a first identifier corresponding to a destination country and a second identifier corresponding to a destination state/province, and the preset address conversion rule comprises an address-identifier correspondence library, and
packing, by the order-receiving carrier system, the packages corresponding to the same address identifier into the large package according to the one or more address identifiers, and sending the one or more large packages and the one or more address identifiers corresponding to the one or more large packages to the distribution carrier system comprises:
packing packages corresponding to the same address identifier into a large package, and adding the address identifier to the large package; and
sending the large package to the distribution carrier system.

5. The logistics distribution method according to claim 4, wherein distributing, by the distribution carrier system, the one or more large packages according to the one or more address identifiers corresponding to the one or more large packages and that are sent by the order-receiving carrier system, the pre-stored address library, and the preset address conversion rule comprises:
sorting the one or more large packages according to the one or more address identifiers adhering to the one or more large packages; and
distributing the one or more large packages to one or more corresponding destination states/provinces according to the address-identifier correspondence library and the address library.

6. The logistics distribution method according to claim 5, wherein:
the address library comprises address names, and the address-identifier correspondence library comprises the address names and identifiers corresponding to the address names, and
converting, by the logistics system, the one or more receiver addresses corresponding to the one or more packages into the one or more address identifiers corresponding to the one or more receiver addresses, according to the pre-stored address library and the preset address conversion rule comprises:
performing word segmentation on the one or more receiver addresses to obtain a plurality of segmented phrases;
performing matching between the plurality of segmented phrases and the address library to obtain one or more matched address names;
searching the address-identifier correspondence library for one or more identifiers corresponding to the one or more address names; and
combining the one or more identifiers of the one or more address names to obtain the one or more address identifiers corresponding to the one or more receiver addresses.

7. The logistics distribution method according to claim 6, wherein the identifier corresponding to the address name includes: a number, a letter or letters, and/or a number-letter combination.

8. The logistics distribution method according to claim 2, wherein the order-receiving carrier system and the distribution carrier system belong to the same entity.

9. The logistics distribution method according to claim 2, wherein, the distribution carrier system comprises:
one or more transit carrier systems; and
a terminal distribution carrier system.

10. The logistics distribution method according to claim 1, further comprising at least one of:
creating, by the logistics system, the address library according to address names, and storing the address library; or
downloading, by the logistics system, the address library from a cloud server, and storing the address library.

11. A logistics distribution system, comprising:
one or more carrier systems; and
a logistics system, configured to convert, one or more receiver addresses corresponding to one or more packages into one or more address identifiers corresponding to the one or more receiver addresses, according to a pre-stored address library and a preset address conversion rule, and send the one or more address identifiers to the one or more carrier systems for logistics distribution of the one or more packages.

12. The logistics distribution system according to claim 11, wherein the one or more carrier systems comprise: an order-receiving carrier system and a distribution carrier system.

13. The logistics distribution system according to claim 12, wherein:
the order-receiving carrier system is configured to pack packages corresponding to the same address identifier into a large package according to the one or more address identifiers, and send one or more large packages and one or more address identifiers corresponding to the one or more large packages to the distribution carrier system; and
the distribution carrier system is configured to distribute the one or more large packages according to: the one or more address identifiers that correspond to the one or more large packages and that are sent by the order-receiving carrier system, the pre-stored address library, and the preset address conversion rule.

14. The logistics distribution system according to claim 13, wherein: the address identifier comprises at least a first identifier corresponding to a destination country and a second identifier corresponding to a destination state/province;
the preset address conversion rule comprises an address-identifier correspondence library; and
to pack the packages corresponding to the same address identifier into the large package according to the one or more address identifiers, and send the one or more large packages and the one or more address identifiers corresponding to the one or more large packages to the distribution carrier system, the order-receiving carrier system is configured to:
pack packages corresponding to the same address identifier into a large package, and add the address identifier to the large package; and
send the large package to the distribution carrier system.

15. The logistics distribution system according to claim 14, wherein, to distribute the one or more large packages according to the one or more address identifiers corresponding to the one or more large packages and that are sent by the order-receiving carrier system, the pre-stored address library, and the preset address conversion rule, the distribution carrier system is configured to:
sort the one or more large packages according to the one or more address identifiers adhering to the one or more large packages; and
distribute the one or more large packages to one or more corresponding destination states/provinces according to the address-identifier correspondence library and the address library.

16. The logistics distribution system according to claim 15, wherein:
the address library comprises address names;
the address-identifier correspondence library comprises the address names and identifiers corresponding to the address names; and
to convert the one or more receiver addresses corresponding to the one or more packages into the one or more address identifiers corresponding to the one or more receiver addresses, according to the pre-stored address library and the preset address conversion rule, the logistics system is configured to:
perform word segmentation on the one or more receiver addresses to obtain a plurality of segmented phrases;
perform matching between the plurality of segmented phrases and the address library to obtain one or more matched address names;
search the address-identifier correspondence library for one or more identifiers corresponding to the one or more address names; and
combine the one or more identifiers of the one or more address names to obtain the one or more address identifiers corresponding to the one or more receiver addresses.

17. The logistics distribution system according to claim 16, wherein the identifier corresponding to the address name includes: a number, a letter or letters, and/or a number-letter combination.

18. The logistics distribution system according to claim 12, wherein, the order-receiving carrier system and the distribution carrier system belong to the same entity.

19. The logistics distribution system according to claim 12, wherein the distribution carrier system comprises:
one or more transit carrier systems; and
a terminal distribution carrier system.

20. The logistics distribution system according to claim 11, wherein the logistics system is configured to perform at least one of:
creating the address library according to address names, and storing the address library; or downloading the address library from a cloud server, and storing the address library.

21. A logistics system, comprising:
a receiving module configured to receive one or more receiver addresses corresponding to one or more packages;
an address identifier generation module configured to convert the one or more receiver addresses corresponding to one or more packages into one or more address identifiers corresponding to the one or more receiver addresses according to a pre-stored address library and a preset address conversion rule; and
a sending module configured to send the one or more address identifiers to one or more carriers for logistics distribution of the one or more packages.
